(19) United States
(12) Patent Application Publication
(10) Pub. No.: US 2013/0232848 A1
(43) Pub. Date: Sep. 12, 2013

(54) Trap Attachment for a Soup Can

(71) Applicant: Christopher Robert RYAN, Bennet, NE (US)

(72) Inventor: Christopher Robert RYAN, Bennet, NE (US)

(21) Appl. No.: 13/789,674

(22) Filed: Mar. 7, 2013

Related U.S. Application Data
(60) Provisional application No. 61/607,986, filed on Mar. 7, 2012.

(51) Int. Cl. A01M 23/18

(52) U.S. Cl. CPC A01M 23/18
USPC 43/61

(57) ABSTRACT

A trap attachment for a soup can is an apparatus that is inserted into a soup can or any kind of container in order to create an animal trap. The apparatus is primarily used to catch raccoons by their paw. The apparatus includes a face plate, a trap hole, a hollow body, a torsion spring, a trap door, and a trigger. The hollow body is the structural component of the apparatus and is inserted into the soup can. The face plate prevents the apparatus from being inserted too far into the soup can. The trap hole allows an animal's paw to enter the hollow body through the face plate. The trigger allows the animal's paw to activate the trap door, which closes off the trap hole and pins the animal's paw. The torsion spring forces the trap door to close when the trigger is tripped by the animal's paw.

The current application claims a priority to the U.S. Provisional Patent application Ser. No. 61/607,986 filed on Mar. 7, 2012.

### FIELD OF THE INVENTION

The present invention relates generally an apparatus for a trap. More specifically, the present invention is an apparatus for a soup can trap that utilizes an average soup can.

### BACKGROUND OF THE INVENTION

Most standard traps require a raccoon or other animal to actually enter the trap, triggering a door to be closed behind the animal. Often, however, animals are smart and become suspicious about standard trap designs, making the design less effective. Additionally, animal traps are often harmful to the animal by having sharp clamps that snap and attach to the animal's leg. It is therefore an object of the present invention to create a new safe design for a trap that can be easily camouflaged which can catch the animal by the hand and keep the animal in place until captured by a user.

### BRIEF DESCRIPTION OF THE DRAWINGS

FIG. 1 is a front perspective view of the present invention in the set position.

FIG. 2 is a back perspective view of the present invention in the set position.

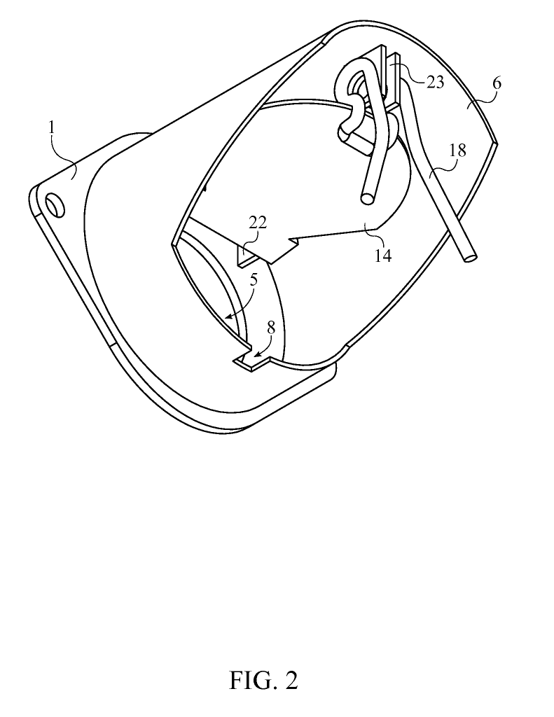

FIG. 3 is a back perspective view of the present invention in the sprung position.

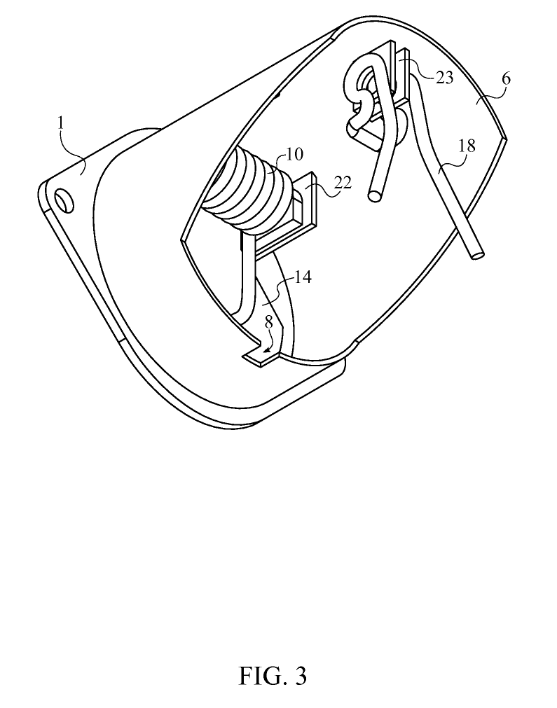

FIG. 4 is a front perspective view of the face plate, the hollow body, the first axle mechanism, and the second axle mechanism for the present invention.

FIG. 5 is a back perspective view of the face plate, the hollow body, the first axle mechanism, and the second axle mechanism for the present invention.

FIG. 6 is a perspective view of the trap door for the present invention.

FIG. 7 is a perspective view of the torsion spring for the present invention.

FIG. 8 is a perspective view of the trigger for the present invention.

### DETAIL DESCRIPTIONS OF THE INVENTION

All illustrations of the drawings are for the purpose of describing selected versions of the present invention and are not intended to limit the scope of the present invention.

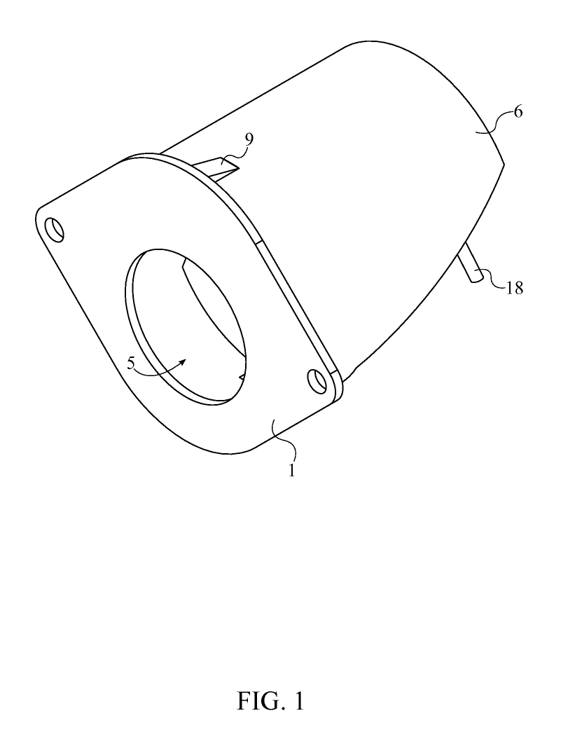

As can be seen in FIG. 1, the present invention is a trap attachment for a soup can, which is inserted into the soup can in order to create an animal trap. The present invention is designed to appear like the natural habitat of bait. In the preferred embodiment, the present invention is specifically designed to catch the paw of a raccoon and to appear like the natural habitat of a crawfish. Also in the preferred embodiment, the present invention is designed to prevent the capture of a dog or other domestic animal. The present invention mainly comprises a face plate 1, a trap hole 5, a hollow body 6, a centering gap 8, a latch protrusion 9, a torsion spring 10, a trap door 14, a trigger 18, a first axle mechanism 22, and a second axle mechanism 23. The hollow body 6 allows the present invention to be inserted into a soup can or any other kind of hole. The face plate 1 has an unusual shape and is used as a stop to prevent the hollow body 6 from being inserted too far into the soup can. The latch protrusion 9 is used to keep the soup can situated on the present invention once the hollow body 6 is inserted into the soup can. The centering gap 8 allows the present invention to be orientated in a particular way while the hollow body 6 is traversing into the soup can. The trap hole 5 allows an animal to insert their paw through the face plate 1 and into the hollow body 6. The first axle mechanism 22 allows the pan 15 and the torsion spring 10 to freely rotate within the hollow body 6. The second axle mechanism 23 allows the trigger 18 to freely rotate within the hollow body 6. The first axle mechanism 22 and the second axle mechanism 23 allow the trap door 14 and the trigger 18 to engage and disengage from each other. Once the animal's paw trips the trigger 18, the torsion spring 10 pushes the trap door 14 against the face plate 1 in order to close off the trap hole 5.

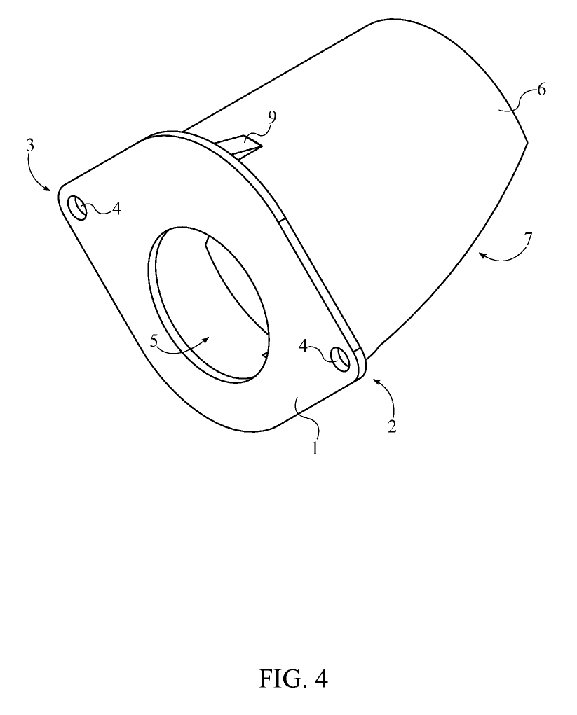

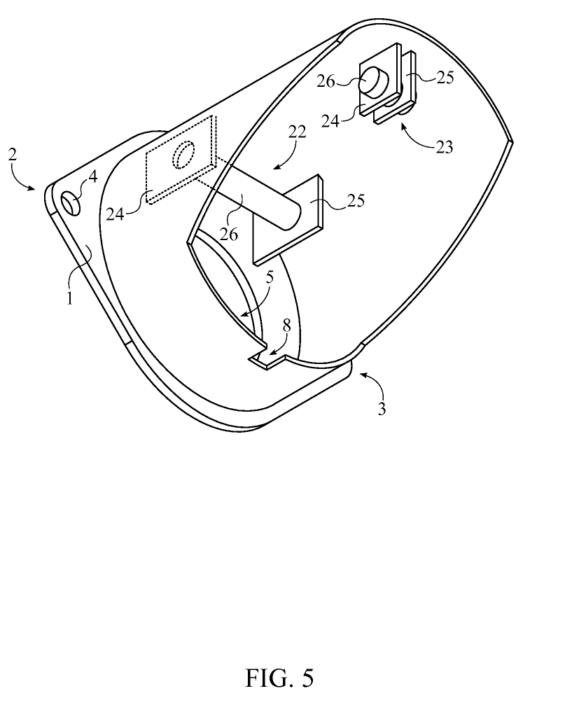

The face plate 1 and the hollow body 6 are used as the structural components of the present invention so that the other components can be properly positioned and connected to the present invention. The face plate 1 and the hollow body 6 are shown in FIGS. 4 and 5. The face plate 1 comprises a left extended portion 2 and a right extended portion 2. The left extended portion 2 and the right extended portion 2 provide the face plate 1 with an irregular shape and prevent the present invention from rolling within the soup can. The irregular shape also deters animals from digging out the present invention. The left extended portion 2 and the right extended portion 2 is positioned opposite to each other across the face plate 1. In addition, the left extended portion 2 and the right extended portion 2 each comprise an attachment hole 4, which is used to attach a chain or any other kind of restraint and holds the present invention in place. The attachment hole 4 of the of the left extended portion 2 is centrally positioned on the left extended portion 2, and the attachment hole 4 of the right extended portion 2 is centrally positioned on the right extended portion 2, which allows both attachment holes 4 to evenly distribute the restraining force on the face plate 1. The hollow body 6 is used to house the mechanical components of the present invention and is used to structural support the lateral wall of the soup can. The hollow body 6 is concentrically connected to the face plate 1 so that the hollow body 6 remains in between the left extended portion 2 and the right extended portion 2. The hollow body 6 comprises a tapered section 7, which allows the hollow body 6 to be more efficiently inserted into the soup can. Consequently, the tapered section 7 is positioned on the hollow body 6 opposite to the face plate 1. In the preferred embodiment, the face plate is made of 12 gauge metal and the trap body is made of 16 gauge metal.

This configuration for the face plate 1 and the hollow body 6 creates the framework that can be used to connect and to position all of the other components. The trap hole 5 is used as the entrance to the hollow body 6 and is positioned to traverse through the face place and into the hollow body 6. The latching protrusion is used as the means to secure the present invention to the soup can and is positioned to exteriorly connect to the hollow body 6 adjacent to the face plate 1. Thus, once the hollow body 6 traverses into the soup can, the open end of the soup can will be pressed against the face plate 1, and the inner rim of soup can will be notched in between the face plate 1 and the latch protrusion 9. In terms of the centering gap 8, a different protrusion can be built into a soup can, wherein this protrusion is pointed towards the center axis of the soup can. The centering gap 8 is used to engage this protrusion so that the hollow body 6 has the proper angular orientation within the soup can. The centering gap 8 traverses from the tapered section 7 towards the face plate 1. For functional efficiency, the centering gap 8 and the latch protrusion 9 is diametrically opposed to each other around the hollow body 6. In the preferred embodiment, the trap hole 5 is 1.625 inches in diameter, which ideal for a raccoon's paw, and the hollow body 6 is 2.75 inches in diameter, which is ideal to fit into a soup can.

In reference to FIGS. 4 and 5, the first axle mechanism 22 and the second axle mechanism 23 are also positioned in terms of the framework of the face plate 1 and the hollow body 6. The first axle mechanism 22 is interiorly connected to the hollow body 6 adjacent to the face plate 1 so that the first axle mechanism 22 can guide the rotational movement of the trap door 14 and the torsion spring 10. The second axle mechanism 23 is interiorly connected to the hollow body 6 adjacent to the tapered section 7 so that the second axle mechanism 23 can guide the rotational movement of the trigger 18. The first axle mechanism 22 and the second axle mechanism 23 are aligned to each other along the hollow body 6, which allows the trap door 14 and the trigger 18 to properly engage and disengage from each other. Furthermore, the first axle mechanism 22 and the second axle mechanism 23 each comprise a left axle tab 24, a right axle tab 25, and a shaft 26. The rotational movement of the trigger 18, the trap door 14, or the torsion spring 10 occurs about the shaft 26. In order to facilitate this rotational movement without interference from the inner surface of the hollow body 6, the shaft 26 must be spaced away from the inner surface of the hollow body 6. The left axle tab 24 and the right axle tab 25 position the shaft 26 away from the inner surface of the hollow body 6. The left axle tab 24 and the right axle tab 25 are parallel with each other and are connected adjacent to inner surface of the hollow body 6. The shaft 26 is perpendicularly positioned to both the left axle tab 24 and the right axle tab 25 and opposite to the inner surface of the hollow body 6, which enables the proper rotational movement between the trap door 14, the torsion spring 10, and the trigger 18.

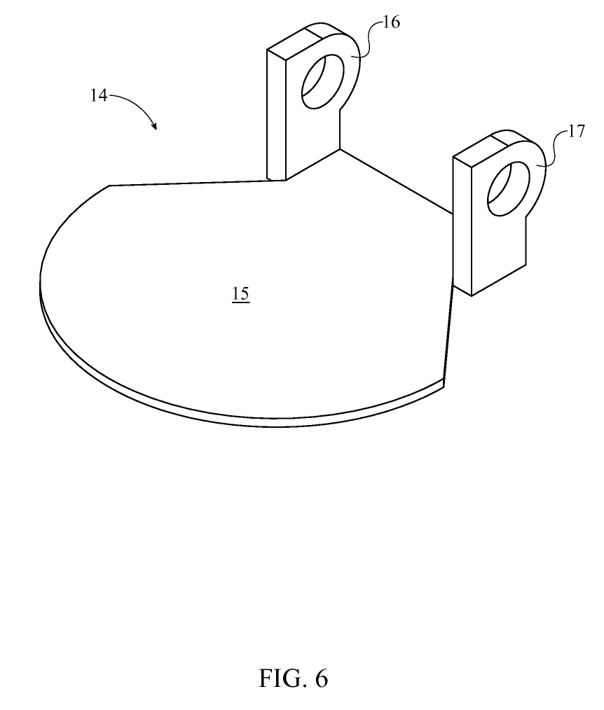

As can be seen in FIG. 6, the trap door 14 is designed to engage the trigger 18 and to completely close off the trap hole 5. The trap door 14 comprises a pan 15, a left door tab 16, and a right door tab 17. The pan 15 is flat piece of material and is sized to be able to freely swing within the hollow body 6. The pan 15 should be large enough to cover the trap hole 5 with some overhang, but the pan 15 should be small enough to touch the inner surface of the hollow body 6. In the preferred embodiment, the pan acts a guide for a raccoon's paw so that the raccoon's paw stays centered along the hollow body 6. Once the trap door 14 is activated, the pan 15 prevents the animal from gaining access to the inner mechanical components in order to free itself from the present invention. The left door tab 16 and the right door tab 17 properly position the pan 15 away from the first axle mechanism 22 so that the pan 15 does not interfere with the rotational movement of the trap door 14. Thus, the left door tab 16 and the right door tab 17 are connected adjacent to the pan 15 and are positioned normal to the pan 15.

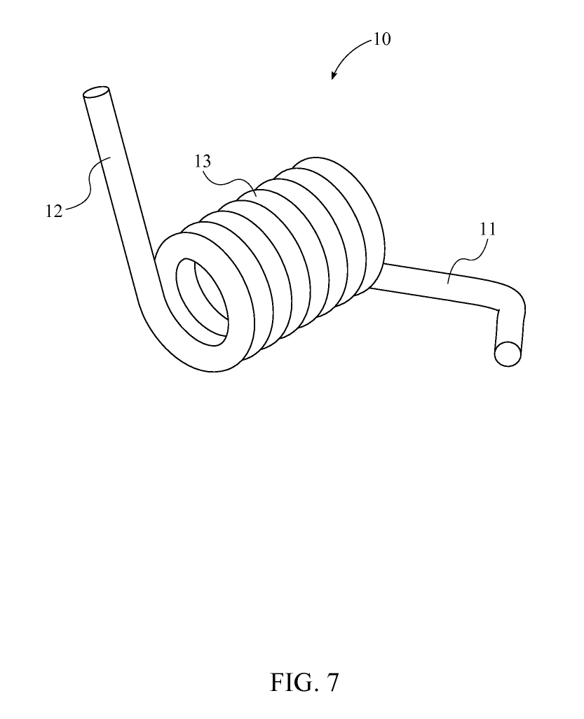

As can be seen in FIG. 7, the torsion spring 10 forces the trap door 14 to seal off the trap hole 5 once the trap door 14 disengages the trigger 18. The torsion spring 10 comprises a first leg 11, a second leg 12, and a coil 13. The coil 13 is used to store the potential energy when the trap door 14 is engaged to the trigger 18. A twisting force can be applied on the coil 13 through the first leg 11 and the second leg 12. Consequently, the first leg 11 is connected adjacent to the coil 13, and the second leg 12 is connected adjacent to the coil 13 opposite to the first leg 11. The first leg 11 is pressed against the pan 15, and the second leg 12 is pressed against the hollow body 6. The first leg 11 and the second leg 12 squeeze together and twist the coil 13 in opposite directions as the trap door 14 engages the trigger 18. The coil 13 is also positioned in between the left door tab 16 and the right door tab 17 so that first axle mechanism 22 can uniformly rotate both the trap door 14 and the torsion spring 10. Thus, the left door tab 16, the right door tab 17, and the coil 13 are rotatably connected to the first axle mechanism 22, which allows the trap door 14 and the torsion spring 10 to be rotatably connected to the first axle mechanism 22. More specifically, the left door tab 16, the right door tab 17, and the coil 13 are positioned in between the left axle tab 24 and the right axle tab 25 of the first axle mechanism 22. This allows the shaft 26 of the first axle mechanism 22 to traverse through the left axle tab 24 of the first axle mechanism 22, the left door tab 16, the coil 13, the right door tab 17, and the right axle tab 25 of the first axle mechanism 22.

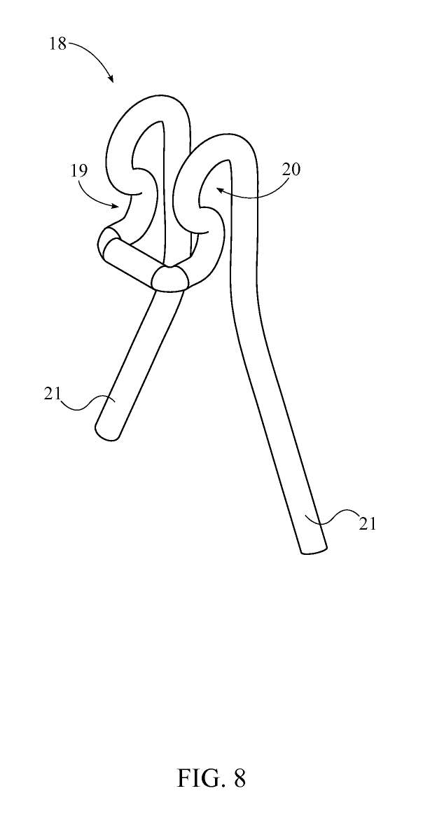

As can be seen in FIG. 8, the trigger 18 holds the trap door 14 in place, until an animal presses the trigger 18 and releases the trap door 14 from the trigger 18. The trigger 18 comprises a hooked portion 19, a pivot portion 20, and a pair of tines 21. The pivot portion 20 allows trigger 18 to be rotatably connected to the second axle mechanism 23. The pair of tines 21 is stretched across the interior of the hollow body 6, which allows an animal to trip the trigger 18 by pressing against the pair of tines 21. The pair of tines 21 maximize the probability of the trigger 18 is tripped by the animal. The pair of tines 21 will rotate when an animal presses against them because the pair of tines 21 is connected adjacent to the pivot portion 20. The hooked portion 19 is positioned toward the first axle mechanism 22 and allows the trigger 18 to grasp the edge of the pan 15. The hooked portion 19 will also rotate when an animal presses against the pair of tines 21 because the hooked portion 19 is connected adjacent to the pivot portion 20. The hooked portion 19 is positioned along the pair of tines 21 so that the pan 15 is perpendicularly positioned to the pair of tines 21 while the edge of the pan 15 engages the hooked portion 19. The pivot portion 20 must be rotatably connected to the second axle mechanism 23, which allows the trigger 18 to be rotatably connected to the second axle mechanism 23. More specifically, the left axle tab 24 and the right axle tab 25 of the second axle mechanism 23 are positioned within the pivot portion 20. This allows the shaft 26 of the second axle mechanism 23 to traverse through the left axle tab 24 of the first axle mechanism 22, the right axle tab 25 of the second axle mechanism 23, and the pivot portion 20. Consequently, this configuration allows the hooked portion 19 to be engaged by the pan 15 and allows the hooked portion 19 to be disengaged from the pan 15 when the pair of tines 21 is rotated by an animal. Furthermore, the trigger 18 is moved into the set position simply by using gravity to swing the trigger 18 under the pan 15 when the pan 15 is fully depressed into the hollow body 6. The top of the trigger 18 is formed to allow the trigger 18 to swing forward and backward, as well as to toggle slightly side to side for increased stability.

The present invention can be used on anything with about a three inch opening and sufficient room for the trigger to actuate such plastic pipes or steel cylinders. The present invention is not intended to only be used with a soup can, but may be used with any type of container device of sufficient size to insert the present invention inside of an opening in the container. If desired, the present invention may also be used without inserting the present invention into the soup can or container. The present invention comprises the following uses that are possible when using the soup can:
1. The present invention can be laid right on the ground out in the open.
2. The trap is fixed to a wooden object with the use of the additional 0.25 inch hole on the face plate.
3. The trap is suspended from the ground by use of a chain or any other means.
4. The most significant advantage of this design of trap is that it can be placed at the water's edge of any body of water with a soil composition that allows the user to push the trap vertically into the ground up to just before the top of the soup can. This allows the bottom of the trap to be under the water level, and does not allow the water to enter the trap. This keeps bait fresh and makes the present invention looks like natural habitat. Specifically, the present invention looks like a crawdad holes. This further allows the user to conceal the trap.
5. Another significant use for the trap is to dig the trap into the side of a bank, where the soil allows the user to actually just push the trap right into the mud.
6. The trap can be set vertically, horizontally, or virtually any way as long as there is access to the opening.
7. The trap can be suspended by either an attachment point and it will hang at about a sixty degree angle to the ground. This keeps even dry bait in the trap and doesn't allow it to roll out.

In addition, the present invention comprises the following uses that are possible without using the soup can:
1. The present invention can be placed in any matter the trapper believes it will work for their intent.
2. The present invention can be placed into any material with a hole of roughly three inches and a depth which will allow the trigger sufficient room to actuate.

Although the invention has been explained in relation to its preferred embodiment, it is to be understood that many other possible modifications and variations can be made without departing from the spirit and scope of the invention as hereinafter claimed.

1. A trap attachment for a soup can comprises:
a face plate;
a trap hole;
a hollow body;
a latch protrusion;
a torsion spring;
a trap door;
a trigger;
a first axle mechanism;
a second axle mechanism;
said face plate comprises a left extended portion and a right extended portion;
said hollow body comprises a tapered section and a centering gap;
said torsion spring comprises a first leg, a second leg, and a coil;
said trap door comprises a pan, a left door tab, and a right door tab;
said trigger comprises a hooked portion, a pivot portion, and a pair of tines; and
said first axle mechanism and said right axle mechanism each comprise a left axle tab, a right axle tab, and a shaft.

2. The trap attachment for a soup can as claimed in claim 1 comprises:
said left extended portion and said right extended portion being positioned opposite to each other across said face plate;
said left extended portion and said right extended portion each comprise a attachment hole;
said attachment hole of said left extended portion being centrally positioned on said left extended portion; and
said attachment hole of said right extended portion being centrally positioned on said right extended portion.

3. The trap attachment for a soup can as claimed in claim 1 comprises:
said hollow body being concentrically connected to said face plate;
said tapered section being positioned on said hollow body opposite to said face plate;
said trap hole traversing through said face plate and into said hollow body;
said latch protrusion being exteriorly connected to said hollow body adjacent to said face plate;
said centering gap traversing from said tapered section towards said face plate;
said centering gap and said latch protrusion being diametrically opposed to each other around said hollow body;
said first axle mechanism being interiorly connected to said hollow body adjacent to said face plate;
said second axle mechanism being interiorly connected to said tapered section adjacent to said tapered section; and
said first axle mechanism and said second axle mechanism being aligned with each other along said hollow body.

4. The trap attachment for a soup can as claimed in claim 1 comprises:
said left axle tab and said right axle tab being parallel with each other;
said left axle tab and said right axle tab being connected adjacent to said hollow body; and
said shaft being perpendicularly positioned to both said left axle tab and said right axle tab and opposite to said hollow body.

5. The trap attachment for a soup can as claimed in claim 1 comprises:
said first leg being connected adjacent to said coil;
said second leg being connected adjacent to said coil opposite to said first leg;
said first leg being pressed against said trap door and said second leg being pressed against said hollow body;
said left door tab and said right door tab being connected adjacent to said pan;
said left door tab and said right door tab being positioned normal to said pan; and
said coil being positioned in between said left door tab and said right door tab.

6. The trap attachment for a soup can as claimed in claim 1 comprises:
said pair of tines being connected adjacent to said pivot portion;
said hooked portion being connected adjacent to said pivot portion;
said hooked portion being positioned along said pair of tines; and
said hooked portion being positioned towards said first axle mechanism.

7. The trap attachment for a soup can as claimed in claim 1 comprises:
said left door tab, said right door tab, and said coil being rotatably connected to said first axle mechanism;
said pivot portion being rotatably connected to said second axle mechanism; and
said hooked portion being engaged by said pan, wherein said pair of tines are rotated in order to disengage said pan from said hooked portion.

8. The trap attachment for a soup can as claimed in claim 7 comprises:
said left door tab, said right door tab, and said coil being positioned in between said left axle tab and said right axle tab of said first axle mechanism; and
said shaft of said first axle mechanism traversing through said left axle tab of said first axle mechanism, said left door tab, said coil, said right door tab, and said right axle mechanism of said second axle mechanism.

9. The trap attachment for a soup can as claimed in claim 7 comprises:
said left axle tab and said right axle tab of said second axle mechanism being positioned within said pivot portion; and
said shaft of said second axle mechanism traversing through said left axle tab of said first axle mechanism, said right axle tab of said second axle mechanism, and said pivot portion.

10. A trap attachment for a soup can comprises:
a face plate;
a trap hole;
a hollow body;
a latch protrusion;
a torsion spring;
a trap door;
a trigger;
a first axle mechanism;
a second axle mechanism;
said face plate comprises a left extended portion and a right extended portion;
said hollow body comprises a tapered section and a centering gap;
said torsion spring comprises a first leg, a second leg, and a coil;
said trap door comprises a pan, a left door tab, and a right door tab;
said trigger comprises a hooked portion, a pivot portion, and a pair of tines;
said first axle mechanism and said right axle mechanism each comprise a left axle tab, a right axle tab, and a shaft;
said hollow body being concentrically connected to said face plate;
said tapered section being positioned on said hollow body opposite to said face plate;
said trap hole traversing through said face plate and into said hollow body;
said latch protrusion being exteriorly connected to said hollow body adjacent to said face plate;
said centering gap traversing from said tapered section towards said face plate;
said centering gap and said latch protrusion being diametrically opposed to each other around said hollow body;
said first axle mechanism being interiorly connected to said hollow body adjacent to said face plate;
said second axle mechanism being interiorly connected to said tapered section adjacent to said tapered section; and
said first axle mechanism and said second axle mechanism being aligned with each other along said hollow body.

11. The trap attachment for a soup can as claimed in claim 10 comprises:
said left extended portion and said right extended portion being positioned opposite to each other across said face plate;
said left extended portion and said right extended portion each comprise a attachment hole;
said attachment hole of said left extended portion being centrally positioned on said left extended portion;
said attachment hole of said right extended portion being centrally positioned on said right extended portion;
said left axle tab and said right axle tab being parallel with each other;
said left axle tab and said right axle tab being connected adjacent to said hollow body; and
said shaft being perpendicularly positioned to both said left axle tab and said right axle tab and opposite to said hollow body.

12. The trap attachment for a soup can as claimed in claim 10 comprises:
said first leg being connected adjacent to said coil;
said second leg being connected adjacent to said coil opposite to said first leg;
said first leg being pressed against said trap door and said second leg being pressed against said hollow body;
said left door tab and said right door tab being connected adjacent to said pan;
said left door tab and said right door tab being positioned normal to said pan;
said coil being positioned in between said left door tab and said right door tab;
said pair of tines being connected adjacent to said pivot portion;
said hooked portion being connected adjacent to said pivot portion;
said hooked portion being positioned along said pair of tines; and
said hooked portion being positioned towards said first axle mechanism.

13. The trap attachment for a soup can as claimed in claim 10 comprises:
said left door tab, said right door tab, and said coil being rotatably connected to said first axle mechanism;
said pivot portion being rotatably connected to said second axle mechanism;
said hooked portion being engaged by said pan, wherein said pair of tines are rotated in order to disengage said pan from said hooked portion;
said left door tab, said right door tab, and said coil being positioned in between said left axle tab and said right axle tab of said first axle mechanism;
said shaft of said first axle mechanism traversing through said left axle tab of said first axle mechanism, said left door tab, said coil, said right door tab, and said right axle mechanism of said second axle mechanism;
said left axle tab and said right axle tab of said second axle mechanism being positioned within said pivot portion; and
said shaft of said second axle mechanism traversing through said left axle tab of said first axle mechanism, said right axle tab of said second axle mechanism, and said pivot portion.

14. A trap attachment for a soup can comprises:
a face plate;
a trap hole;
a hollow body;
a latch protrusion;
a torsion spring;
a trap door;
a trigger;
a first axle mechanism;
a second axle mechanism;
said face plate comprises a left extended portion and a right extended portion;
said hollow body comprises a tapered section and a centering gap;
said torsion spring comprises a first leg, a second leg, and a coil;
said trap door comprises a pan, a left door tab, and a right door tab;
said trigger comprises a hooked portion, a pivot portion, and a pair of tines;
said first axle mechanism and said right axle mechanism each comprise a left axle tab, a right axle tab, and a shaft;
said hollow body being concentrically connected to said face plate;
said tapered section being positioned on said hollow body opposite to said face plate;
said trap hole traversing through said face plate and into said hollow body;
said latch protrusion being exteriorly connected to said hollow body adjacent to said face plate;
said centering gap traversing from said tapered section towards said face plate;
said centering gap and said latch protrusion being diametrically opposed to each other around said hollow body;
said first axle mechanism being interiorly connected to said hollow body adjacent to said face plate;
said second axle mechanism being interiorly connected to said tapered section adjacent to said tapered section;
said first axle mechanism and said second axle mechanism being aligned with each other along said hollow body;
said pair of tines being connected adjacent to said pivot portion;
said hooked portion being connected adjacent to said pivot portion;
said hooked portion being positioned along said pair of tines;
said hooked portion being positioned towards said first axle mechanism;
said left door tab, said right door tab, and said coil being rotatably connected to said first axle mechanism;
said pivot portion being rotatably connected to said second axle mechanism; and
said hooked portion being engaged by said pan, wherein said pair of tines are rotated in order to disengage said pan from said hooked portion.

15. The trap attachment for a soup can as claimed in claim 14 comprises:
said left extended portion and said right extended portion being positioned opposite to each other across said face plate;
said left extended portion and said right extended portion each comprise a attachment hole;
said attachment hole of said left extended portion being centrally positioned on said left extended portion;
said attachment hole of said right extended portion being centrally positioned on said right extended portion;
said first leg being connected adjacent to said coil;
said second leg being connected adjacent to said coil opposite to said first leg;
said first leg being pressed against said trap door and said second leg being pressed against said hollow body;
said left door tab and said right door tab being connected adjacent to said pan;
said left door tab and said right door tab being positioned normal to said pan; and
said coil being positioned in between said left door tab and said right door tab.

16. The trap attachment for a soup can as claimed in claim 14 comprises:
said left axle tab and said right axle tab being parallel with each other;
said left axle tab and said right axle tab being connected adjacent to said hollow body; and
said shaft being perpendicularly positioned to both said left axle tab and said right axle tab and opposite to said hollow body.

17. The trap attachment for a soup can as claimed in claim 14 comprises:
said left door tab, said right door tab, and said coil being positioned in between said left axle tab and said right axle tab of said first axle mechanism;
said shaft of said first axle mechanism traversing through said left axle tab of said first axle mechanism, said left door tab, said coil, said right door tab, and said right axle mechanism of said second axle mechanism;
said left axle tab and said right axle tab of said second axle mechanism being positioned within said pivot portion; and
said shaft of said second axle mechanism traversing through said left axle tab of said first axle mechanism, said right axle tab of said second axle mechanism, and said pivot portion.
